(19) United States
(12) Patent Application Publication
(10) Pub. No.: US 2010/0171730 A1
(43) Pub. Date: Jul. 8, 2010

(54) DISPLAY

(75) Inventors: Masahiko Kobayakawa, Kyoto (JP); Hiroki Ishinaga, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi, Kyoto (JP)

(21) Appl. No.: 12/602,043

(22) PCT Filed: May 28, 2008
(86) PCT No.: PCT/JP2008/059770

§ 371 Date: Nov. 25, 2009

(30) Foreign Application Priority Data
May 29, 2007 (JP) 2007-141627

(51) Int. Cl. G06F 3/038; G02F 1/13357

(52) U.S. Cl. 345/211; 362/97.1

(57) ABSTRACT

A display (A) includes a light source unit (1) for illuminating a planar region and a plurality of filter elements arranged in a matrix. Each of the filter elements transmits light emitted from the light source unit (1) and having a wavelength lying within a predetermined range. The light source unit (1) includes a plurality of semiconductor light emitting devices (2) arranged in a matrix on a common board. Each of the semiconductor light emitting devices (2) is adapted to emit white light including three wavelength peaks lying in a blue range, a green range and a red range, respectively.

### TECHNICAL FIELD

The present invention relates to a display for displaying color images, and particularly relates to a display including a plurality of semiconductor light emitting devices for illuminating a planar region.

### BACKGROUND ART

FIG. 5 illustrates the conventional liquid crystal display disclosed in Patent Document 1 below. The display X illustrated in the figure includes an illumination unit 91 and a liquid crystal panel 92. The illumination unit 91 includes a plurality of linear light sources (cold-cathode tubes) 91a for emitting white light. The liquid crystal panel 92 includes a pair of transparent substrates 92a, 92b, a sealing member 92c, a liquid crystal layer 92d and a filter 92e. On the lower transparent substrate 92a, a plurality of TFT devices (not shown) are arranged in a matrix. The liquid crystal layer 92d is provided by loading a liquid crystal material in the space enclosed by the transparent substrates 92a, 92b and the sealing member 92c. The filter 92e functions to appropriately scatter external light.

The display X can be used as an image displaying apparatus of a mobile phone or personal computer. The display X still has room for improvement of the image quality. To improve the image quality, both of the color reproducibility and the contrast need to be enhanced. To enhance the color reproducibility, clear white light needs to be emitted from the light source, i.e., the three colors (red, green and blue) necessary for image display need to have sufficient intensity in each peak wavelength. However, the white light emitted from the cold-cathode tubes 91a of the display X does not meet the requirement, so that there are limitations on the enhancement of the color reproducibility. Further, it is impossible to provide local contrast control for the light emitted from the cold-cathode tube 91a, which is a single linear light source.

Patent Document 1: JP-A-2007-123030

### DISCLOSURE OF THE INVENTION

The present invention has been proposed under the circumstances described above. It is therefore an object of the present invention to provide a display having enhanced color reproducibility and contrast.

According to the present invention, there is provided a display including a light source unit for illuminating a planar region and a plurality of filter elements arranged in a matrix. Each of the filter elements transmits light emitted from the light source unit and having a wavelength lying within a predetermined range. The light source unit includes a plurality of semiconductor light emitting devices arranged in a matrix. Each of the semiconductor light emitting devices is adapted to emit white light including three wavelength peaks lying in a blue range, a green range and a red range, respectively.

With this arrangement, the light emitted from the light source unit is clear white light having high brightness. By causing this light to pass through the filter elements, light having high saturation is obtained. Thus, with this arrangement, the color reproducibility and contrast of the display is enhanced.

Preferably, the display of the present invention further includes a controller for individual brightness control of the lights emitted from the semiconductor light emitting devices, respectively. With this arrangement, a color image with high contrast is displayed by controlling the brightness of the light to be emitted from each semiconductor light emitting device in accordance with the brightness distribution of the color image to be displayed.

Other features and advantages of the present invention will become more apparent from the detailed description given below with reference to the accompanying drawings.

### BRIEF DESCRIPTION OF THE DRAWINGS

FIG. 1 is an exploded perspective view illustrating a principal portion of a display according to the present invention.

FIG. 2 is a sectional view taken along lines II-II in FIG. 1.

FIG. 3 is a graph illustrating the light emission spectrum of a semiconductor light emitting device used in the display of FIG. 1.

FIG. 4 is a schematic view illustrating a pixel and filter elements of the display of FIG. 1.

FIG. 5 is a sectional view illustrating an example of conventional display.

### BEST MODE FOR CARRYING OUT THE INVENTION

Preferred embodiments of the present invention are described below with reference to the accompanying drawings.

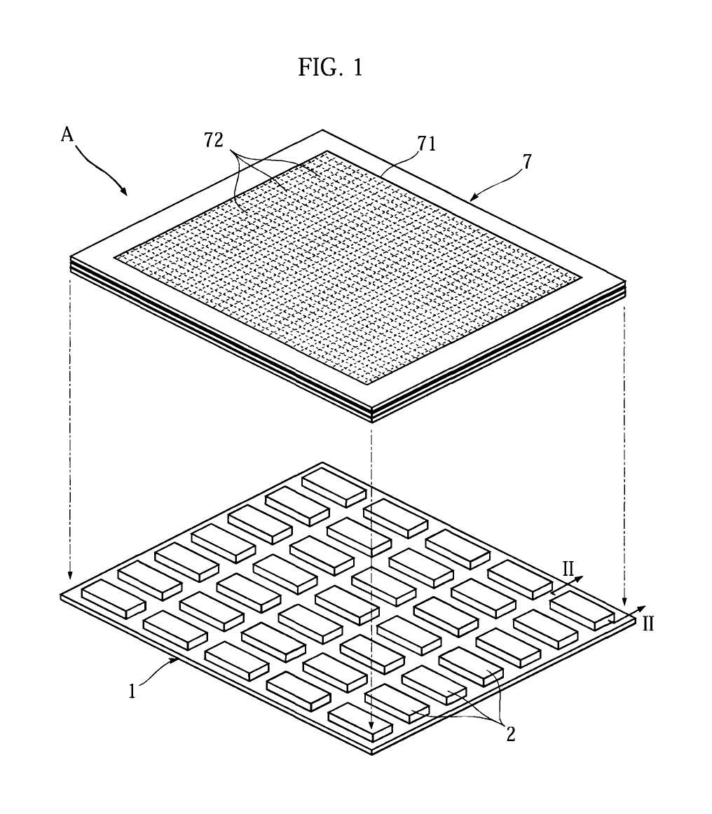

FIG. 1 illustrates an example of a display according to the present invention. The illustrated display A is configured as a liquid crystal display capable of displaying color images, and includes a light source unit 1 and a liquid crystal panel 7.

The light source unit 1 is adapted to emit planar white light toward the liquid crystal panel 7 and includes a plurality of semiconductor light emitting devices 2. The semiconductor light emitting devices 2 are arranged in a matrix on a common board.

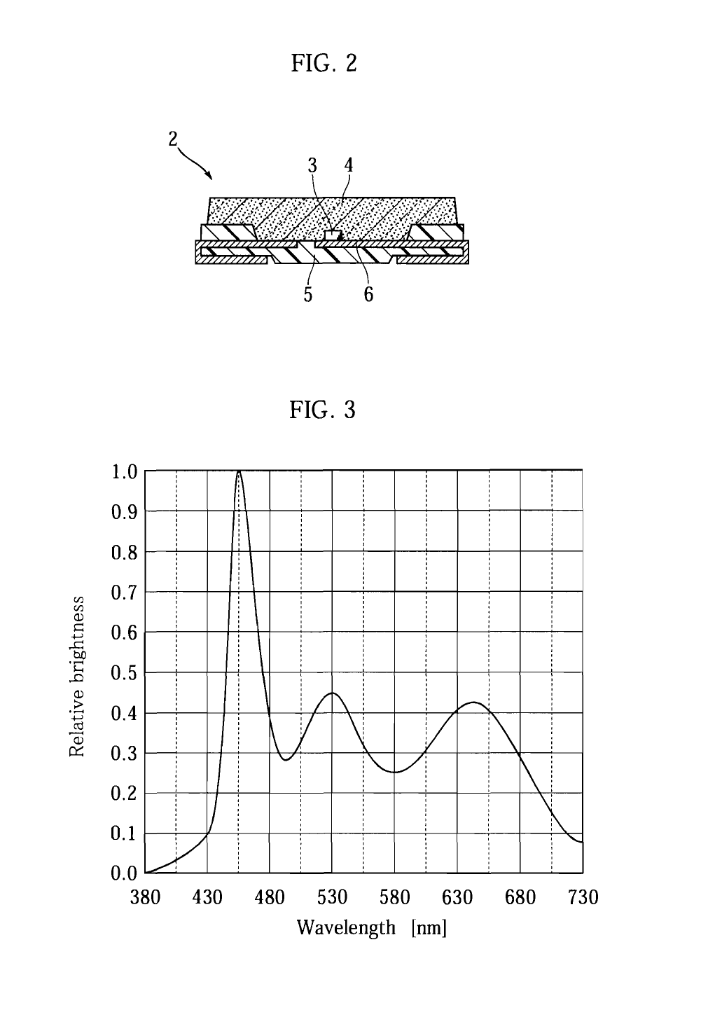

As illustrated in FIG. 2, each of the semiconductor light emitting devices 2 includes a semiconductor light emitting element 3, light transmitting resin 4, a case 5 and a lead 6. The semiconductor light emitting element 3 has a laminated structure made up of a plurality of semiconductor layers made of e.g. InGaN and is designed to emit blue light. The light transmitting resin 4 is made of a transparent resin mixed with a red fluorescent material and a green fluorescent material. The red fluorescent material is a substance which emits red light when excited by the light (blue light) emitted from the semiconductor light emitting element 3. Examples of the red fluorescent material include REuW₂O₈ (where R is at least one of Li, Na, K, Rb and Cs), M₂Si₅N₈:Eu (where M is at least one of Ca, Sr and Ba), CaS:Eu and SrS:Eu. The green fluorescent material is a substance which emits green light when excited by the light emitted from the semiconductor light emitting element 3. Examples of the green fluorescent material include BaMgAl₁₀O₁₇:Eu, ZnS:Cu and MGa₂S₄:Eu (where M is at least one of Ca, Sr and Ba). The lead 6 supports the semiconductor light emitting element 3 and is used for supplying electric power to the semiconductor light emitting element. The case 5 surrounds the semiconductor light emitting element 3 and includes a reflective surface for reflecting the light from the semiconductor light emitting element 3.

FIG. 3 is a graph illustrating the light emission spectrum of the semiconductor light emitting device 2. As illustrated in the figure, the light emission spectrum of the semiconductor light emitting device 2 has three peaks. The first peak is present at a wavelength of approximately 450 nm. The first peak is due to the blue light emitted from the semiconductor light emitting element 3. The second peak is present at a wavelength of approximately 530 nm. The second peak is due to the green light emitted from the green fluorescent material excited by the blue light from the semiconductor light emitting element 3. The third peak is present at a wavelength of approximately 640 nm. The third peak is due to the red light emitted from the red fluorescent material excited by the blue light from the semiconductor light emitting element 3.

The liquid crystal panel 7 forms a color image by utilizing the planar white light emitted from the light source unit 1. The liquid crystal panel 7 includes a display region 71 for displaying a color image. The display region 71 is made up of a plurality of pixels 72 arranged in a matrix. The basic structural elements (such as a pair of transparent substrates and a liquid crystal layer sealed between the substrates) are the same as e.g. the conventional liquid crystal panel 92 illustrated in FIG. 5.

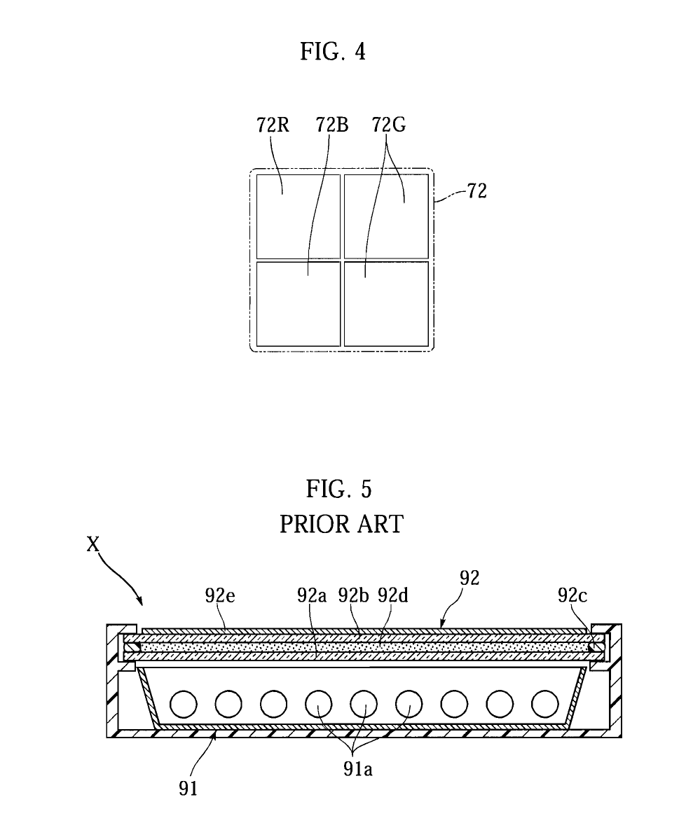

As illustrated in FIG. 4, each pixel 72 is made up of a red filter element 72R, two green filter elements 72G and a blue filter element 72B. The red filter element 72R includes a minute portion of the liquid crystal layer (i.e., the portion whose state of polarization is controlled by a TFT device incorporated in the liquid crystal panel 7) and a red filter layer covering the minute portion. Similarly, each of the green filter elements 72G includes a minute portion and a green filter layer covering the minute portion. The blue filter element 74B includes a minute portion and a blue filter layer covering the minute portion.

As will be understood from FIG. 1, the size of each semiconductor light emitting device 2 in plan view is larger than that of each pixel 72. Thus, the light emitted from one semiconductor light emitting device 2 passes through a plurality of pixels 72. Each of the semiconductor light emitting devices 2 is controlled individually by a controller such as a CPU incorporated in the display A. With this arrangement, it is possible to control the semiconductor light emitting devices 2 e.g. in such a manner that the brightness of the semiconductor light emitting device 2 arranged at a certain position in the display region 71 be maximum while the brightness of the semiconductor light emitting device 2 arranged at another position be zero.

The advantages of the display A are described below.

As illustrated in the light emission spectrum of FIG. 3, the light emitted from the light source unit 1 has a brightness distribution including peaks lying in the red wavelength range, the green wavelength range and the blue wavelength range, respectively. Such light is clear white light, and thus suitable for enhancing the maximum brightness of color images to appear on the display A. In addition, by causing the light emitted from the light source unit 1 to pass through the red filter element 72R, the green filter elements 72G and the blue filter element 72B, it is possible to obtain red light, green light and blue light each having enhanced saturation and lightness. Consequently, color images with enhanced color reproducibility can be produced.

The brightness of each semiconductor light emitting device 2 can be controlled individually in accordance with the brightness distribution of a color image to be displayed. Specifically, the brightness of a semiconductor light emitting device 2 corresponding to a dark portion of a color image can be made relatively low, whereas the brightness of a semiconductor light emitting device 2 corresponding to a light portion of the color image can be made relatively high. Thus, the display of the present invention can display a darker black than the black displayed by the conventional liquid crystal display X. This is because the display A of the present invention is capable of displaying an image, with the light source (i.e., the semiconductor light emitting device 2) at the corresponding position turned off, while the conventional liquid crystal display X cannot help displaying, with the light source 91a kept on (the pixel at the corresponding portion is completely closed). Thus, the display A of the present invention is suitable for displaying a color image with high contrast.

1. A display comprising:
a light source unit for illuminating a planar region; and
a plurality of filter elements arranged in a matrix, each of the filter elements being adapted to transmit light that is emitted from the light source unit and has a wavelength lying within a predetermined range;
wherein the light source unit includes a plurality of semiconductor light emitting devices arranged in a matrix, each of the semiconductor light emitting devices being adapted to emit white light including three wavelength peaks lying in a blue range, a green range and a red range, respectively.

2. The display according to claim 1, further comprising a controller for performing individual brightness control of the lights emitted from the semiconductor light emitting devices, respectively.
